(19) United States
(12) Patent Application Publication
(10) Pub. No.: US 2026/0241962 A1
(43) Pub. Date: Aug. 20, 2026

(54) PLATFORM GATE SUPPORT SYSTEM AND METHOD

(71) Applicant: Overhead Door Corporation, Lewisville, TX (US)

(72) Inventor: Federico Romero, Corpus Christi, TX (US)

(21) Appl. No.: 19/055,104

(22) Filed: Feb. 17, 2025

(51) Int. Cl. B61B 1/02; E06B 11/02

(52) U.S. Cl. CPC B61B 1/02; E06B 11/026

(57) ABSTRACT

A support system for barrier doors is provided. The system includes: a loading platform having an edge defining an end of the platform; a barrier located along at least a portion of the edge for inhibiting objects from falling off of the platform on to a vehicle pathway; barrier doors located in the barrier to allow, when opened, passage through the barrier; an unsupported portion of the platform defining at least in part a space below the unsupported portion of the platform; a frame for supporting the barrier doors, the frame and barrier doors configured to be located proximate to the edge of the platform; and a frame support configured to attach to the frame and support the frame and the barrier doors, the frame support extending below the platform.

### TECHNICAL FIELD

The present disclosure relates generally to a support system for a barrier, and more particularly to a support system for a frame supporting barrier doors at a transportation platform.

### BACKGROUND

Transportation systems such as passenger rail systems, (whether commuter or long distance), monorails, subways, light rail systems, metro systems, tubes, and the like (generally referred to herein as “trains” whether steel wheels and rails are used by the transportation system or not) have long used platforms elevated above the rail bed or track to facilitate passengers (and freight) loading on and off trains. In recent years, there has been an uptick of passengers and/or other items being pushed or otherwise falling off the train platform onto the pathway or track of an oncoming train.

In order to reduce the likelihood of people or objects falling off platform onto the tracks, some transportation systems are considering erecting barriers along the edge of the platform. Doors or gates in the barrier will remain closed when a train is coming, going, or not present at a platform, but may open when a train is stopped at a platform to allow a pathway through the barrier to permit loading and unloading of the train.

A problem with retroactively installing barriers to existing platforms is that they were not originally designed to support the weight of a barrier near the edge of the platform. Further, there may not be much extra space on a platform, so it may be desirable to use space efficiently for any barrier system.

### SUMMARY

The foregoing needs are met to a great extent by embodiments in accordance with the present disclosure, wherein, in some embodiments allow barriers and/or portions of barrier systems such as door frames to be supported by a means other than the platform. Further, some embodiments allow for barrier systems and corresponding supports to be efficiently designed so as to not take up unnecessary space.

The disclosure describes a support system for barrier doors. The system includes: a loading platform having an edge defining an end of the platform; a barrier located along at least a portion of the edge for inhibiting objects from falling off of the platform on to a vehicle pathway; barrier doors located in the barrier to allow, when opened, passage through the barrier; an unsupported portion of the platform defining at least in part a space below the unsupported portion of the platform; a frame for supporting the barrier doors, the frame and barrier doors configured to be located proximate to the edge of the platform; and a frame support configured to attach to the frame and support the frame and the barrier doors, the frame support extending below the platform.

In another aspect, the disclosure describes a method of supporting barrier doors for a loading platform. The method includes: installing a frame support to a foundation located below the platform; attaching the frame support to a door frame proximate to the platform; supporting barrier doors with the door frame, wherein the barrier doors are part of a barrier proximate to the platform configured to inhibit objects from moving off of the platform and onto a vehicle pathway located below the platform.

In yet another aspect, the disclosure describes a support system for barrier doors. The support system includes: a transportation loading platform having an edge defining an end of the platform; a frame for supporting barrier doors, the frame and barrier doors configured to be part of a barrier located along at least a portion of the edge for inhibiting objects from falling off of the platform, the barrier configured to be located proximate to the edge of the platform; and a frame support configured to attach to the frame and support the frame and the frame support extending below the platform, wherein the frame and frame support are configured in one of two ways: the frame support is attached to the frame and adjacent to the platform and the platform is not located between the frame and the frame support or the frame and frame support are connected via a transmission member and at least one fastener wherein the transition member and at least one fastener extend through the platform.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate aspects of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is partial cross-sectional view of a train at a platform showing an embodiment of the present disclosure.

FIG. 2 is partial side view the platform, barrier, door frame, and frame supports in accordance with the present disclosure.

FIG. 3 is partial side view the platform, barrier, door frame, and frame supports in accordance with another embodiment of the present disclosure.

FIG. 4 is a partial end view of another embodiment in accordance with the present disclosure.

### DETAILED DESCRIPTION

The aspects of the disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

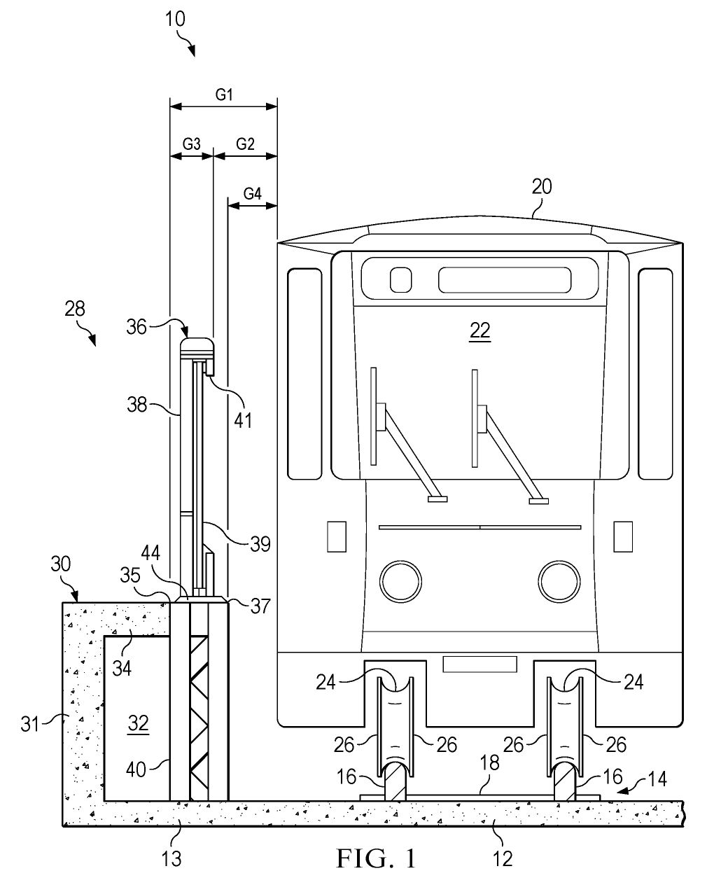

FIG. 1 is a cross-sectional view of a portion of a transportation system 10. The transportation system 10 may include a rail bed 12 which optionally may include a foundation 13. In other embodiments than what is shown in FIG. 1, the rail bed 12 and foundation 13 may be separate from each other. As shown in FIG. 1, the rail bed 12 supports the track 14 which includes rails 16 and ties 18. A train 20 which may include a single or multiple train cars 22 rides on the rails 16 via wheels 24. Most train wheels 24 include one or more flanges 26 that help keep the wheels 24 positioned on the rails 16.

The transportation system 10 will have various stations 28 that allows for the train 20 or other vehicle to stop for loading passengers and/or cargo. It should be understood that rail beds 12 are not the only type of vehicle pathway 12 used in various embodiments. In embodiments that use other vehicles other than trains 20, the railbed 12 would be substituted for a roadbed 12 or any other suitable vehicle pathway.

To facilitate the loading and/or unloading of passengers and/or cargo, platforms 30 are used. The platform provides at least two functions. One, it provides flat surface for staging loading and unloading. Second the platform is located to near the floor of the train cars 22 so that people and/freight may be loaded without (or at least the minimal use of) stairs, ladders or ramps to ingress or egress in or out of the train cars 22. When a train 20 pulls into a station 28 the doors on the train 20 open and people and freight will be at essentially the same level as the platform 30 so passengers may simply step off the platform 30 and onto the train 20 or vice versa. Similarly, freight and other objects may easily be transferred on or off of the train 20 on or off of the platform 30.

It will be understood that while the transportation system 10 is described herein as a train 20 with a rail system, but is not limited to include vehicles that ride on steel rails. Rather various embodiments in accordance with the disclosure may include any type of transportation system where vehicles associated with the transportation system drive on a pre-determined roadbed located below a raised platform similar to as described herein. For example, in addition to rail systems, transpiration systems in accordance with this disclosure may include, buses, trolleys, monorail system, magnetic lift systems, or any other form of transport.

As shown in FIG. 1, the platform 30 is supported by platform supports 31. In some embedment’s the platform supports 31, may be manmade or in other embodiments, the platform 30 is set on the ground.

Many transportation systems 10 have a crawl space 32 under the platform 30. Often a part or portion 34 of the platform 30 overhangs the space 32. The space 32 may be used as a place of refuge in case a train 20 comes when someone is on the rail bed 12 and is unable to get up onto the platform 30 before the train 20 enters the station 28. In other embodiments, the space 32 may be used to store track maintenance items, conduit or anything else that may be desired to be located near the roadbed 12 and also avoid trains 20. The end of the platform 30 defines an edge 35.

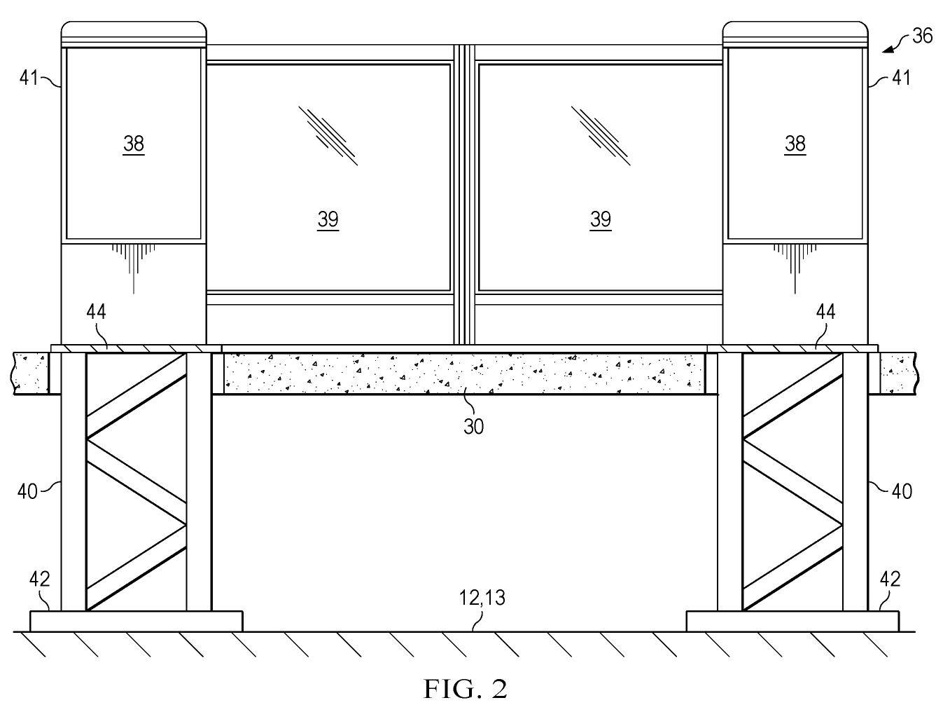

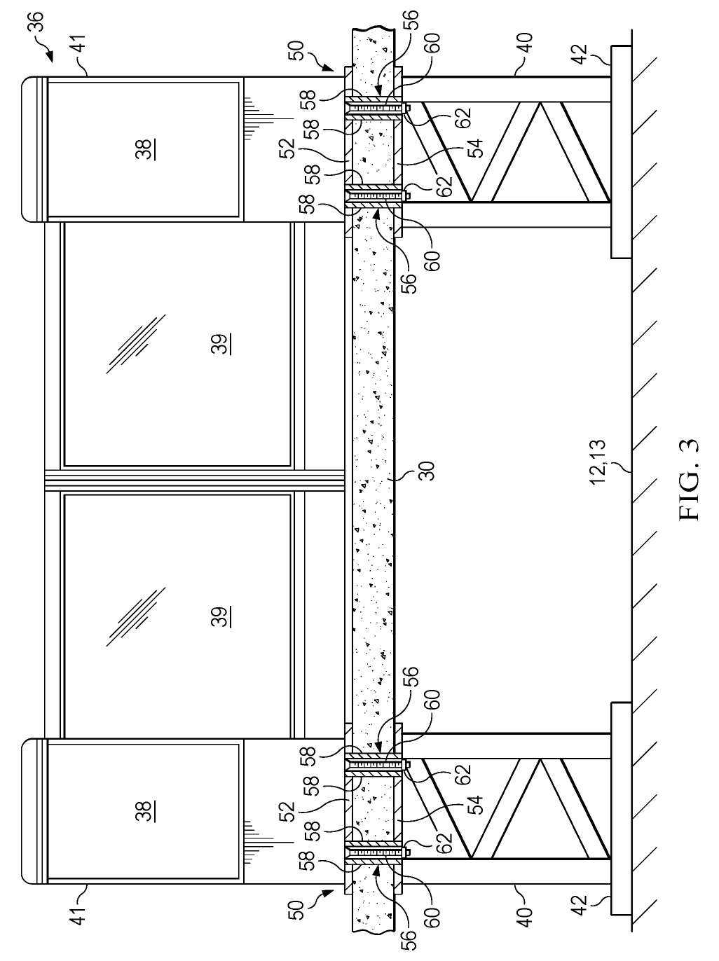

Due to an increase of passengers being pushed off or falling off the platform 30 and onto the tracks 14 or road bed 12 below the platform 30, there has been a desire to install a barrier system 36 near the edge 35 of the platform 30. If the barrier system 36 is not on the platform 30 as shown in FIGS. 1 and 2, the edge of the platform is located as indicated by reference character 35 in FIG. 1. If the barrier system 36 is located on the platform as shown in FIG. 3, the located of the edge is indicated by reference character 37 in FIG. 1.

Mounting a barrier system 36 onto existing platforms 30 can provide a variety of technical challenges. For example, often it would be desirable to locate the barrier system 36 near the edge 35 37 of the platform 30 but this location is likely on the overhang portion 34 of the platform. The overhang portion 34 may not have been engineered to support the weight of the barrier system 36. In addition, space on the platform may be crowded at times and space is at a premium. The barrier system 36 cannot be so big as to take up the clearance between the train 20 (or other vehicle) and the platform 30. In some instances, there may only be about 10 inches of space to allow for the thickness of the barrier system 36.

The barrier system 36 may include barrier panels 38, barrier gates or doors 39, barrier support structure 40, a frame 41 for the gates or doors 39 and a base plate 42. As shown in the FIGS., barrier system 36 includes static panels 38 that may be located along the edge 35 of the platform 30. In order to provide selective access through the barrier system 36, doors or gates 39 are located at intervals in the barrier system 36. When a train 20 or other vehicle stops at a station 28 care is taken so that doors on the train 20 or other vehicle align with the doors or gates 39 of the barrier system 36. Then the doors on the train 20 and barrier doors 39 open to allow loading and unloading of the train 20. In the embodiment shown in the FIGS, the doors or gates 39 slide to the open and closes position. In other embodiments, the barrier doors or gates 39 may pivot or articulate any other suitable way.

The doors or gates 39 are supported by a frame 41. Because the frame 41 supports the doors or gates 39, the frame 41 is heavier than normal panels 38. As mentioned elsewhere herein, the platform 30 and particularly the overhanging portion of the platform 34 may not have been designed to support the weight of the frame 41. Therefore, barrier support structures 40 are located under the frames 41. In some embodiments, barrier support structure 40 may also be located at additional or other locations along the barrier 36.

The barrier support structure 40 may be comprised of a truss structure as shown in the FIGS, a concrete column, steel beams, or any other suitable structure to support all or a substantial portion of the weight of the barrier and/or the barrier frame 41. As shown in FIG. 2 and 3, the support structure 40 may sit upon a base 42 sitting on the foundation 13 or, as shown, the barrier frame 41 may sit directly on the foundation 13. In this manner, the weight or at least a substantial portion of the weight of the frame 41 and/or other parts of the barrier 36 are supported by the foundation 13. As discussed elsewhere herein, the foundation 13 may be part of the railbed 12 or separate from the railbed 12.

In some embodiments. The barrier support structure 40 may not be attached to the platform 30. In other embodiments, the barrier support structure 40 is attached to the platform 30 in order to provide lateral stability and/or help laterally locate the barrier support structure 40.

As discussed elsewhere herein, it may be desirable to have the barrier system 36 and barrier support system 41 have a small footprint and be thin. Various dimensions related to keeping the barrier system 36 and barrier support system 41 thin and maintain the clearances between the train 20, barrier system 36, barrier support system 41 and edge 35 of the platform 30 are illustrated in FIG. 1. G1 is the distance between the edge 35 of the platform 30 and the train 20. G2 is the distance between the edge 37 of the platform 30 (or edge of the barrier system 36 and the train 20. G3 shows the thickness of the barrier system 36. G4 shows the distance between the train 20 and the part of the barrier support system 40 nearest the train 20. In some embodiments, G3 does not exceed 10 inches.

FIGS. 1 and 2 show an optional embodiment were the frame 41 attaches to the barrier support structure 40 via an optional transition plate 44. In some embodiments, the frame 41, may attach directly to the barrier support structure 40 without a transition plate 44. Whether or not the transitional plate 44 is used, attaching the frame 41 to the support structure 40 may be done using fasteners, welding, adhesives, any combination of these or using any other suitable manner.

In the embodiment shown in FIGS. 1 and 2, the platform 30 is not located between the frame 41 and the barrier support structure 40, but rather the platform 30 and edge 35 are located adjacent to the frame 41 and barrier support structure 40. These embodiments avoid stressing the platform 30 and/or the overhanging portion 34 of the platform with the weight of the frame 41 (and by extension the doors or gates 39) as the weight of these items are borne by the barrier support structure 40.

In the embodiment shown in FIG. 3, the platform 30 and in some instances the overhanging portion 34 of the platform 30 is located between the frame 41 and the barrier support structure 40. However, many of these embodiments avoid unduly stressing the overhanging portion 34 of the platform or the platform 30 because much or all of the weight for the frame 41 (and doors or gates 39) are transferred to and borne by the barrier support structure 40.

In the embodiment shown in FIG. 3, a mounting structure 50 is used that includes a top mounting plate 52 and bottom mounting plate 54 and connected holes 56. The holes 56 may be connected by tubes 48 that define walls. In other embodiment, no tubes 58 are used, but holes in the platform 30 will define walls. Fasteners 60 such as bolts may extend through a portion of the frame 41, the top mounting plate 52, the holes 56, tubes 58, bottom mounting plate 54 and a portion of the barrier supports 40. Nuts 62 are then tightened onto the bolts 60 to fasten the components together. Other suitable fasting techniques such as welding, complimentary fitting components, adhesives or any other suitable fastening strategy may be employed. In some embodiments, the top mounting plate 52 may be part of and/or integrated into the frame 41. In some embodiments, the bottom mounting plate 54 may be part of and/or integrated into part of the support structure 40.

It should be understood that while the frame 41 and the barrier support structure 40 have been described as separate elements, in other embodiments, they may be combined and unitized to be a single structure. In such embodiments, the terms “frame” 41 and “barrier support structure” 40 should be considered not as separate structures but different regions of the same structure. In such embodiments, when this disclosure may refer to the frame “attached” to a barrier support structure, it will be understood that unitized frames and barrier support structures are inherently “attached” to each other.

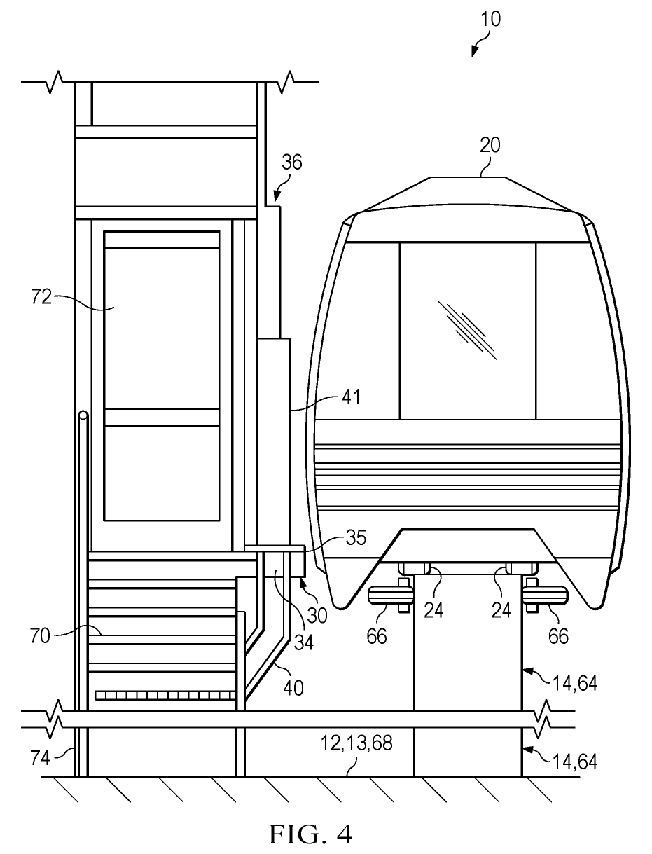

FIG. 4 shows an embodiment where an elevated train 20 rides on a monorail 64 which serves as the train’s 20 track 14. The train 20 has weight bearing wheels 24 as well as guide wheels 66 to keep the train 20 on the monorail 64. The train 20 and platform 30 are elevated above the ground 68, rail bed 12, or foundation 13. Ultimately the rail bed 12 (if used) and foundation 13 will rest on the ground 68. The platform 30 may be accessed by stairs 70 and a door 72 may permit access to the platform 30. The platform 30 may have an overhang portion 34 or if raised enough, all, or substantially all, of the platform 30 could be considered as an overhang 34 as empty space would be beneath it (other than the platform support system 74).

Like in the other embodiments shown in FIGS. 1-3, the platform 30 of FIG. 4 has an edge 35 and a barrier 36 and frame 41 located proximate to the edge 35. In FIG. 4, the barrier support structure 40 may not extend directly down to the foundation rail bed 12, 13, or ground as shown in FIGS. 1-3, but rather may extend to an intermediate member. The barrier support structure 40 may be angled, curved other otherwise shaped to extend to an intermediate member. For example, the intermediate member may be the platform support 31 (like shown in FIGS. 1-3) or platform support system 74 as shown in FIG. 4. In such instances, the load borne by the platform support 40 is transferred to the foundation 13 (or ground 68) via the platform support 31 (or platform support system 74) or some other intermediate member(s).

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

We claim:

1. A support system for barrier doors comprising:
a loading platform having an edge defining an end of the platform;
a barrier located along at least a portion of the edge for inhibiting objects from falling off of the platform on to a vehicle pathway;
barrier doors located in the barrier to allow, when opened, passage through the barrier;
an unsupported portion of the platform defining at least in part a space below the unsupported portion of the platform;
a frame for supporting the barrier doors, the frame and barrier doors configured to be located proximate to the edge of the platform; and
a frame support configured to attach to the frame and support the frame and the barrier doors, the frame support extending below the platform.

2. The support system of claim 1, further comprising a foundation located below the platform and the foundation supporting the frame support.

3. The support system of claim 2, wherein the vehicle pathway is at least one of either: supported by the foundation or is part of the foundation supporting the frame support.

4. The support system of claim 1, wherein the frame support includes a truss.

5. The support system of claim 1, wherein the frame support includes a concrete pillar.

6. The support system of claim 1, further including multiple frame supports located periodically along the edge of the platform.

7. The support system of claim 1, wherein the frame is directly mounted to the frame support.

8. The support system of claim 1, wherein the frame is mounted to the frame support via a transmission member that is attached to extends through the platform.

9. The support system of claim 1, further comprising fasteners that fasten the frame to the frame support via fasteners that extend through the transmission member.

10. The support system of claim 1, wherein the barrier, barrier doors, frame and frame support have a width of less than 10 inches.

11. A method of supporting barrier doors for a loading platform comprising:
installing a frame support to a foundation located below the platform;
attaching the frame support to a door frame proximate to the platform;
supporting barrier doors with the door frame, wherein the barrier doors are part of a barrier proximate to the platform configured to inhibit objects from moving off of the platform and onto a vehicle pathway located below the platform.

12. The method of claim 11, wherein the frame support includes truss members.

13. The method of claim 11, wherein the frame support includes a concrete column.

14. The method of claim 11, further comprising:
extending a transition member through the platform;
extending a fastener through the transition member; and
attaching the frame support to the frame via the fastener.

15. The method of claim 11, further comprising exposing the frame support on a first side facing an area where a vehicle passes and exposing a second side, opposite the first side of the frame support to a crawl space.

16. The method of claim 15, wherein exposed portions of the first and second sides of the frame support extend substantially along the entire length of the frame support.

17. The method of claim 11, wherein the frame support is attached to the frame and adjacent to the platform and the platform is not located between the frame and the frame support.

18. The method of claim 11, wherein the foundation for the frame support is contiguous with a vehicle pathway.

19. A support system for barrier doors comprising:
a transportation loading platform having an edge defining an end of the platform;
a frame for supporting barrier doors, the frame and barrier doors configured to be part of a barrier located along at least a portion of the edge for inhibiting objects from falling off of the platform, the barrier configured to be located proximate to the edge of the platform; and
a frame support configured to attach to the frame and support the frame and the frame support extending below the platform,
wherein the frame and frame support are configured in one of two ways:
the frame support is attached to the frame and adjacent to the platform and the platform is not located between the frame and the frame support or
the frame and frame support are connected via a transmission member and at least one fastener wherein the transition member and at least one fastener extend through the platform.

20. The support system of claim 19, wherein the frame and frame support a confined within a less than 10 inch width.
